(19) United States
(12) Patent Application Publication
(10) Pub. No.: US 2014/0052501 A1
(43) Pub. Date: Feb. 20, 2014

(54) In service support center and method of operation

(71) Applicants: Richard G. Dickson, Merrimack, NH (US); Ronald E. Wagner, Fleming Island, FL (US); Richard A. Woehl, Nashua, NH (US)

(72) Inventors: Richard G. Dickson, Merrimack, NH (US); Ronald E. Wagner, Fleming Island, FL (US); Richard A. Woehl, Nashua, NH (US)

(21) Appl. No.: 12/800,914

(22) Filed: May 25, 2010

Related U.S. Application Data
(63) Continuation of application No. 12/660,204, filed on Feb. 23, 2010, now abandoned.
(60) Provisional application No. 61/154,595, filed on Feb. 23, 2009.

(51) Int. Cl. G06Q 10/00; G06Q 50/00; G01M 17/00

(52) U.S. Cl. 705/7.37; 705/28; 705/301; 705/305; 701/29.3

(57) ABSTRACT

In a method for in service support for a vehicle fleet wherein the improvement comprises providing Reliability Centered Maintenance (RCM), Conditioned Based Maintenance (CBM), Fleet Management (FM), Vehicle/Component Asset Tracking, Stores/Consumable Inventory, and maintenance management.

### RELATED APPLICATIONS

This is a continuation of co-pending patent application Ser. No. 12/660,204 filed Feb. 23, 2010 entitled In Service Support Center and Method Of Operation and claims rights under 35 USC §119(e) from U.S. Application Ser. No. 61/154,595 filed Feb. 23, 2009, the contents of which are incorporated herein by reference.

### FIELD OF THE INVENTION

The present invention relates to vehicle fleet maintenance and more particularly to an off-platform vehicle support center.

### BACKGROUND OF THE INVENTION

In the prior art manual data collection and forms have been used by maintenance personnel and/or vehicle field service representatives. This data was accumulated in multiple disparate data bases both within the Department of Defense and within industry data collection facilities. The disadvantages of such systems were that there was little or no correlation of data across multiple data sources, with attendant inaccurate or non-existent data collection. Moreover, these systems performed no analysis, trending or aggregation of the manually-collected information.

By way of background, the U.S. Army Vehicle Health Monitoring System (VHMS), the U.S. Marine Corps Embedded Platform Logistics System (EPLS) and Advanced Logistics System (ALS) ground vehicle programs require an off-board enterprise system to solve key customer Condition Based Maintenance (CBM+) and Logistics requirements. The requirements of such entities include improved Operational Availability (Ao), awareness and the like.

More specifically, it will be appreciated that the majority of current military vehicles do not have embedded diagnostic systems, and more importantly do not have systems that support an organization level maintenance program. The desirable organizational level maintenance program would be a multi-level maintenance program with the maintenance performed at the vehicle. The desirable multi-level program would involve reliability center maintenance, diagnostic/prognostic growth support, total asset visibility, condition-based maintenance, trend analysis and data collection.

It is noted that the majority of the current maintenance doctrine within the services is a paper system for recording maintenance activities at the vehicle. Here when maintainers go to a vehicle they detect faults, troubleshoot faults, and record the maintenance event in a manual paper-driven procedure.

Since the vast majority of older military vehicles have very little embedded diagnostics, the existing paper systems to detect and troubleshoot these vehicles do not live up to modern requirements.

Thus, given the fact that the state of the vehicle health monitoring for most military vehicles is antiquated, especially for Line Replaceable Units (LRUs) that are taken off the vehicle, checked and replaced at a depot, there is very little information that can be put into a database over time to deduce what the real failures are in the field, for instance failure mode of the LRU that was pulled.

In short, there is no capability presently for the development of a longer term strategy, or for the generation of deductions based on trend analysis. Thus, at present there is no way to develop statistics that relate to the inherent reliability of the fielded systems. As a result, maintenance ground truth for maintenance events were not regularly inputted into any maintenance management system. Thus, one could not for instance update trouble shooting manuals effectively by drawing upon an organized and accurate database of all field failure root causes, or for calling upon any diagnostic system and maintenance systems or effectiveness procedures. In short, there was no mechanism whereby all the data collected over time for very specific vehicles, for instance the Bradley Fighting Vehicles, was available to make inroads into more effective maintenance, support system optimization or to provide any cost savings.

It is noted that the Army has their own manual system that consists of the 5899 maintenance form. If in fact the maintenance forms are filled out properly and are accurate and are always consistent, and if they are always collected and always brought to the same place to update a database available for all consumers of the information, it would be possible to develop optimized maintenance and support to improve fleet health. However, even if data was brought to the same place for analysis, the information is typically never shared with contractors or those responsible for optimization and maintenance.

Consequently, the ability to have accurately fielded reliability statistics is in question, as is the ability to do enhanced diagnostics or diagnostic upgrades, or for that matter to have the ability to solve any of a variety of fleet maintenance problems. There is, for instance, “no evidence of failure found” data available from prior systems and this has cost the US Army upwards of millions of dollars over a period of years, just for the one major tactical vehicle in the fleet. This is because there has been no off-board enterprise system which provides and integreates services for performing reliability center maintenance, diagnostic/prognostic growth support, total asset visibility, condition-based maintenance, trend analysis and data collection. Thus, for instance the government is never able to truly solve a large number of the vehicle performance issues that would lead to decreasing the maintenance timeline from days needed to be able to fix a vehicle in hours. Thus, heretofore there has been no centralized system for solving reliability improvement problems.

It would therefore be of great advantage to have an infrastructure that would incorporate a collection of services that over time could collect all of the required information from platforms and maintenance locations as well as from logistics locations, and place all of this data in a database where one could apply analysis and prognostication to turn this stored data into useful information for fleet maintenance. As will be appreciated such a system would provide government and other agencies a complete view of fleet health, even down to the individual vehicles themselves, so that for instance major subsystems could be analyzed for fielded vehicles from both a diagnostic and prognostics perspective. Note that prognostics provide a predictive system for determining future faults.

From a hardware perspective it would be useful to have a system which would supply connectivity to platforms that have diagnostics, either resident or embedded, with the information then brought forward to a centralized enterprise that provides enhanced data collection over time. Moreover, for the enterprise it would be desirable to collect the information either wirelessly or via an external cable, for instance via a portable laptop that has connectivity to a secure internet connection where the government could then download all of the maintenance-related information over time into a database. The database in one embodiment should include a number of servers that either reside within the federal government or within a contractor.

From a software perspective it would be useful to have a center to be able to take the information and analyze it and provide decision and support analysis followed by abstracting to provide the requisite views and analysis to the appropriate stakeholders, be they government or civilian optimization and maintenance contractors.

Note, Telenostic systems are described in the following U.S. Patent Applications, filed on even date herewith, assigned to the assignee hereof and incorporated herein by reference: Ser. No. ______ (docket number BAEP 1140) Diagnostic Connector Assembly (DCA) Interface Unit (DIU), Ser. No. ______ (docket number BAEP 1159) Telenostics, Ser. No. ______ (docket number BAEP 1160) Portable Performance Support Device and Method for Use, Ser. No. ______ (docket number BAEP 1161) Telenostics Performance Logic, and Ser. No. ______ (docket number BAEP 1162) Telenostics Certify.

### SUMMARY OF INVENTION

The present invention involves an In Service Support Center (ISSC) which is provided with the core capabilities necessary for information collection, provides a depository, and includes an analysis and assessment system. This system is adapted to use all available automated and manual means of data collection from ground vehicles, personnel, and at strategic information points. The subject in service support center employs a collection of tools and services described in the associated Conception of Operation (CONOPS) document provides. These tools thus enable the development of higher level information intelligence and situational awareness/assessment over time so as to provide an overall support system, increase fleet manager awareness, and reduce life cycle costs associated with sustaining a fleet. In one embodiment of the subject invention the support center provides a centralized database to obtain, process, and store vehicle maintenance and support information.

More particularly the subject in service support center is operated by providing a set of tools to develop an initial capability for Reliability Centered Maintenance (RCM), Condition Based Maintenance (CBM), Fleet Management (FM), Vehicle/Component Asset Tracking, and a database that includes a Stores/Consumables Inventory.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of a vehicle maintenance system showing an outdated fleet health model and a model that utilizes the subject in service support center to collect information, do diagnostics and prognostics and to make the results available to the various constituents;

FIG. 2 is a diagrammatic illustration of the requirements that war fighters have in terms of vehicles and logistical support required for missions;

FIG. 3 is a diagrammatic illustration of on-platform, at-platform and off-platform functionality of a fleet management and health system in which the In Service Support Center plays an integral part;

FIG. 4 is a diagrammatic illustration of the various services at the in service support center provides when interfacing a PMA to various stakeholders interested in acquiring information about the health of an individual vehicle or fleet health;

FIG. 5 is a diagrammatic illustration of the system architecture utilized by the subject in service support center that supports organization and maintenance, illustrating information derived from the vehicles themselves, information from analysts, information from maintenance, logistics personnel in need of immediate support, tactical logistics input from fleet managers, and OEM business LCM management along with organic and OEM logistics/maintenance organization input;

FIG. 6 is a diagrammatic illustration of the system architecture from the point of view of vehicle level information, maintenance level information and command level information respectively on-platform, at-platform, and off-platform;

FIG. 7 is a diagrammatic illustration of the system architecture in view of an operational activity model view showing a flow chart of information from on-platform predictor algorithms, MMS at the platform and MMS and in service support center functions;

FIG. 8 is a diagrammatic illustration of the system architecture from the point of view of operational conductivity; and,

FIGS. 9A and 9B are diagrammatic illustrations of the information obtained and processed starting with diagnostics from a decipher system operating on the vehicle chassis, tactical power, sensing and control integration, tactical mission processing and specific in service support center functions both on-vehicle and off-vehicle to support fleet management.

### DETAILED DESCRIPTION

Before describing the drawings, the present invention provides a support center which identifies the core capabilities necessary for an information collection, depository, analysis and assessment system, using all available automated and manual means of data collection from ground vehicles, personnel, and at strategic information points. The subject support center involves a collection of tools and services that enables the development of higher level information intelligence and situational awareness/assessment over time so that the overall supportability system, fleet manager awareness, and life cycle costs associated with sustaining a fleet are continuously improved.

In the context of functional capabilities, a centralized database is provided to obtain, process and store information and present it to stakeholders.

Those skilled in the art will appreciate that various tools may be used in the efficient practice of this invention. Reliability Centered Maintenance (RCM) analysis may be performed by the Integrated Reliability Centered Maintenance System (IRCMS) tool set which is commercially available from Andromeda Systems, Inc. (ASI) and is currently used extensively throughout the US Navy's NAVAIR community to satisfy their RCM requirements.

Condition Based Maintenance (CBM) analysis and required actions may be performed by a Maintenance Management System (MMS) tool such as SAPPHIRE that is commercially available. MMS tools are currently used throughout the US Army's Aviation community to satisfy their condition based maintenance requirements.

Configuration Management and Serial Number Tracking and Stores and Consumables Inventory Management can be performed by the On Demand Inventory Management System which is commercially available, whereas platform health assessment and visualization may be performed by a decision support center framework of tools developed by Aerosystems International, Inc.

What is now described is a system that shows how a fleet is monitored, with fleet monitoring involving the acquisition and analysis of data from a diverse set of organizations and systems to provide visibility of the location, configuration, condition and state of every vehicle.

Those skilled in the art will appreciate that the In-Service Support Center (ISSC) is an off-platform or vehicle and support system information collection, repository, analysis and assessment enterprise system, using all available automated and manual means of data collection from ground vehicles, personnel, and at strategic information points within the off-board sustainment system for a fleet. The ISSC collection of tools and services develops higher level information intelligence and situational awareness/assessment over time so that the overall supportability system, fleet manager awareness, and life cycle costs associated with sustaining the fleet are continuously improved.

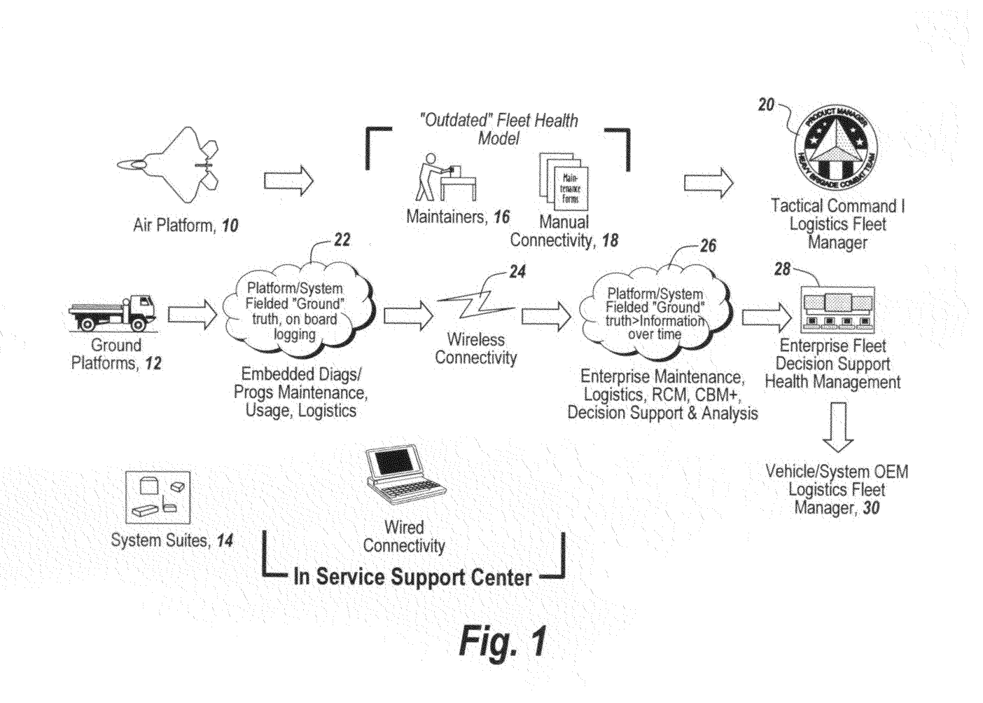

Referring now to FIG. 1, as can be seen, there are a number of different platforms from which to collect information. These include air platforms 10, ground platforms 12 and system fleets 14.

In the past, it will be seen that maintainers 16 manually upload information from these platforms by arriving at the platform with downloading apparatus that manually produces reports and forms as illustrated at 18, based on the data collected.

This outdated fleet health model data is then supplied to tactical command/logistics fleet manager 20. This all paper system has the above noted problems.

On the other hand, the subject system provides an in service support center (ISSC) which establishes platform/system fielded ground truth, utilizing on-board logging techniques as illustrated at 22. This includes embedded diagnostics and prognostics maintenance algorithms and sensors. The subject support center also logs usage and logistics information. This information in one embodiment is provided wirelessly as illustrated at 24 to the support center in terms of platform/system fielded ground truth information collected over time as illustrated at 26. This information includes enterprise maintenance information, logistics, reliability centered maintenance, condition based maintenance, and decision support and analysis, all of which is ported to enterprise fleet decision support/health management experts here illustrated at 28. This information is provided to a vehicle/system organization and maintenance fleet manager in one embodiment, with the management team being able to take the data outputted by the subject support center and put it to use for vehicle health monitoring, maintenance and other sophisticated services.

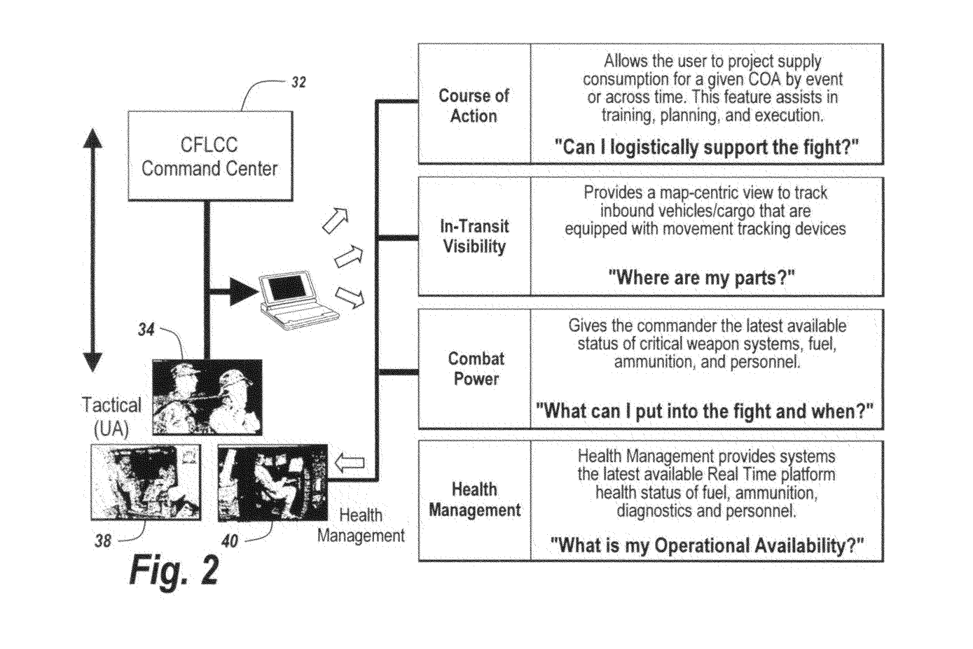

Referring to FIG. 2, the expectation of fleet mangers are categorized by the information that needs to be available at a command center 32 and is available to maintainers. From a tactical perspective at 34 queries are provided to the system through, for instance, a laptop computer 36. These queries address the following functions: first is the course of action that should be undertaken which usually answers the question “can I logistically support the fight?”. This allows the user to project supply consumption for a given central operating authority (COA) by event or across time and assists in training, planning and execution.

The second query has to do with in-transit visibility, for instance “where are my parts?” This portion of the system provides a mapcentric view to track inbound vehicles; cargo and the like that are equipped with movement tracking devices such as GPS or other tracking units.

The next query which is important is the combat power query which asks the question “what can I put into the fight and when?” This gives the commander the latest available status of critical weapon systems, fuel, ammunition and personnel.

The final query that the system is to answer is the health management query “what is my operational availability?”. This health management query provides the latest available realtime platform health status for instance re fuel, ammunition, diagnostics and personnel.

The result of all of this analysis is then to be reported back to the tactical units so that field command determinations can be made based on reliable logistics information.

Here the tactical unit area is shown as having commanders in module 38 or in a van or armored vehicle carrier 40 having communications capabilities.

Thus, mission capability and support are linked for the war fighter, with the subject support center providing the necessary information and analysis.

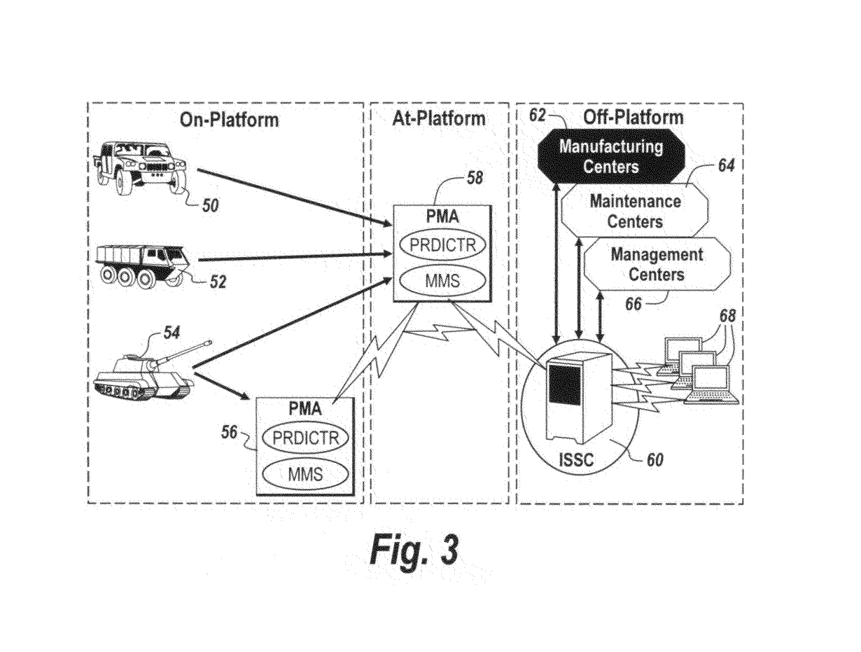

Referring to FIG. 3 as can be seen a platform, namely for instance a Humvee 50, a transport 52 or a tank 54 has embedded diagnosis and prognosticating software in a portable maintenance aid (PMA) here illustrated at 56 which includes the a fault prediction system called PRDICTR system which is the subject of U.S. patent application Ser. No. 12/548,683, filed Aug. 27, 2009, assigned to the assignee hereof and incorporated herein by reference, as well as maintenance management system (MMS) capabilities.

At the platform is also a non-embedded portable maintenance aid 58 which also contains the PRDICTR and maintenance management system capabilities which may be direct coupled to a vehicle.

Thus whether the portable maintenance aid is embedded in the vehicle or at the vehicle, the information relating to diagnostics and predictions is wirelessly sent to the off-platform support center 60. The in service support center communicates with off-platform stakeholders, namely manufacturing centers 62, maintenance center 64 or a management center 66.

Also available from support center 60 are a number of display modules 68 to be able to display the results of the prognostics and diagnostics directly to stakeholders.

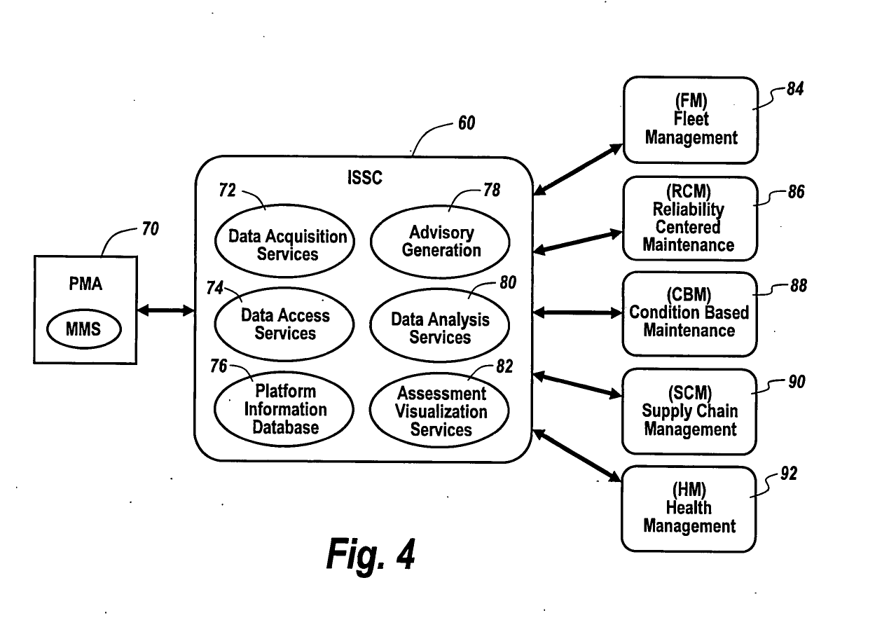

As illustrated in FIG. 4 portable maintenance aids 56 and 58, here illustrated by reference character 70, are coupled to support center 60 that provides the following capabilities and functions, namely data acquisition services 72, data access services 74 and a platform information database 76.

These services include an advisory generation function 78, a data analysis service 80 and assessment and visualization services 82.

The information available from support center 60 is available to fleet management 84 reliability centered maintenance personnel 86, condition-based management personnel 88, supply chain management personnel 90 and health management personnel 92.

A functional description of the information available from various sources and the processing and dissemination of this material is now discussed.

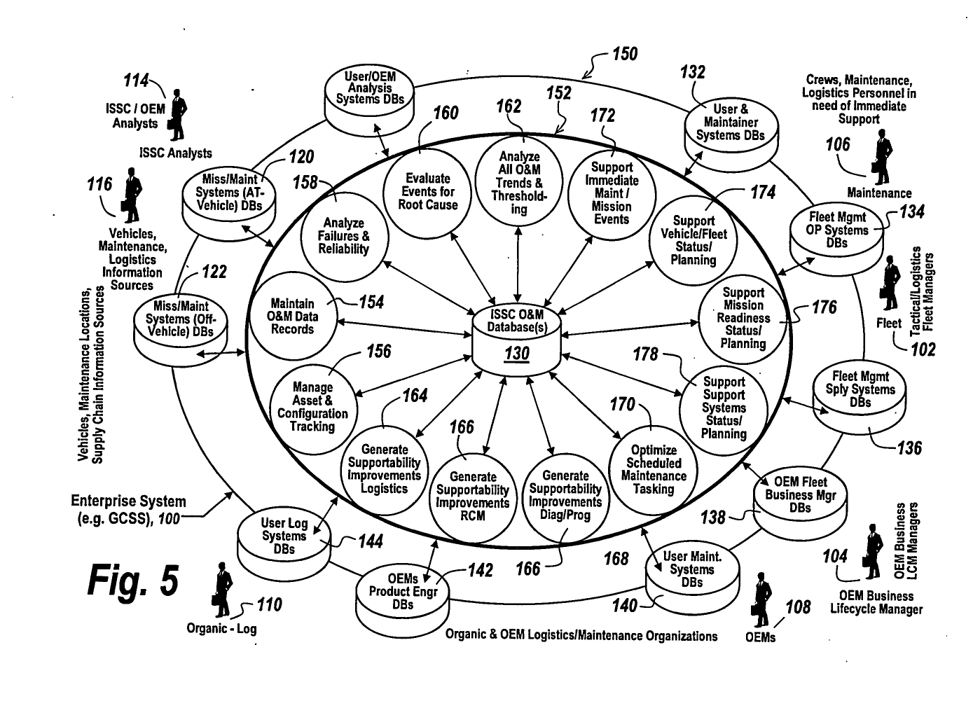

Referring now to FIG. 5 and the subject system in one embodiment constitutes a global combat support system, or enterprise system 100, which has as stakeholders tactical logistics fleet mangers 102, life cycle management 104, crews, maintenance and logistics support personnel in immediate need of support 106, original equipment manufacturers 108, organic logistics personnel 110 and analysts 114.

The fleet vehicles for which maintenance and logistics information is available is illustrated at source 116.

Vehicles, maintenance locations, supply chain information and other vehicle-related sources are shown at mission/maintenance systems vehicle databases 120 and at mission/maintenance systems off-vehicle databases 122. Also available to the support center database, here illustrated at 130, are user and maintainer system databases 132, fleet management operational system databases 134, fleet management supply systems databases 136, optimization and maintenance fleet business manager databases 138, user maintenance system databases 140, optimization and maintenance product engineering databases 142, and user logistics system databases 144.

All of these databases in the outer ring 150 of the enterprise system are coupled to in service support center ring 152 which has at its center the in service support center optimization and maintenance database 130.

It is noted that there is bi-directional communication between the external databases and the support center database such that information can be inputted into the ISSC database, with analysis retrieved from the database.

From the vehicle perspective optimization and maintenance records are available at 154, whereas as illustrated at 156 management asset and configuration tracking interfaces with database 130.

There is a function 158 within the support center that involves analyzing failures and producing statistics with respect to reliability, whereas as illustrated at 160 there is a facility for evaluating events for the root cause of failure and as illustrated at 162 and for analyzing optimization and maintenance trends and thresholding.

As can be seen database 130 is used to generate supportability and improvements, as well as logistics information 164, and supports the generation of supportability improvements with respect to reliability-centered maintenance 166

Information to and from database 130 is used to generate supportability improvements in terms of diagnostics and prognostications as illustrated at 168, whereas database 130 supports the ability to optimize scheduled maintenance tasking as illustrated at 170.

Database 130 is under control of maintenance management which includes for instance the ability to support immediate maintenance and mission events as illustrated at 172, the ability to support vehicle fleet status and planning initiatives illustrated at 174, the ability to output system status and planning as illustrated at 176 and the ability to support mission readiness status and planning as illustrated at 178.

What will be seen is that support system 100 supports inputs of large amounts of data automatically from vehicles, manages the data with respect to diagnosis and prognostication for system faults and errors, reports the availability of vehicles and the like as well as their locations, provides all of the managers ready access to fleet information and provides an output to crews and maintenance personnel in need of immediate support based on the analysis from an embedded system, an at-platform system or through the analysis performed at the subject off-platform support center.

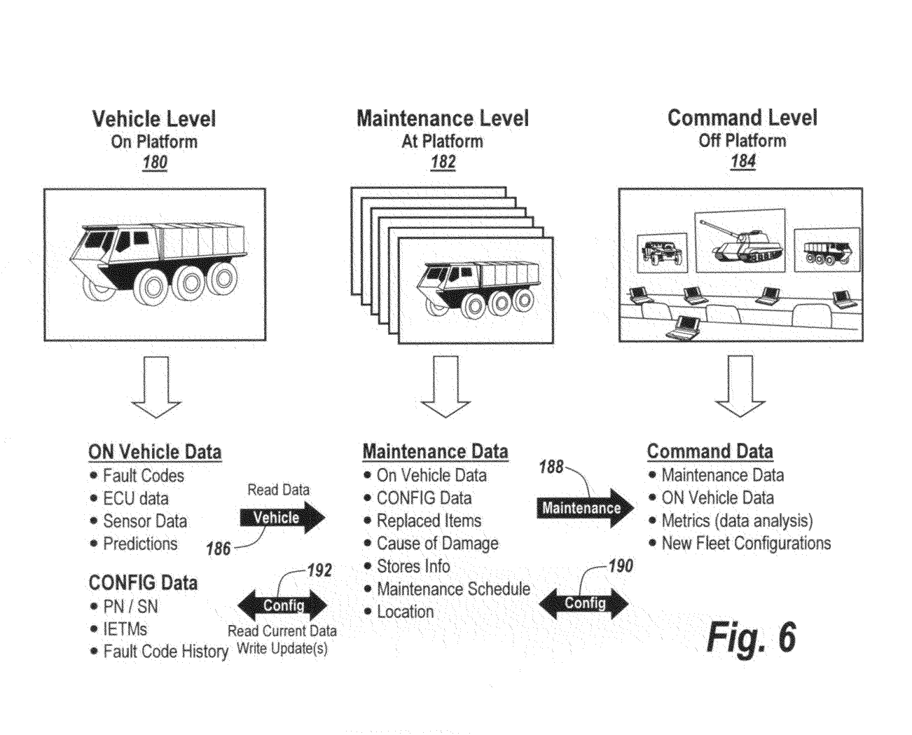

Referring to FIG. 6, the type of logical data at the vehicle level 180 at the maintenance level 182 and at the command level 184 is now described.

With respect to vehicle level 180, on-vehicle data can include fault codes, engine control unit (ECU) data, sensor data and predications. This data is read out at the maintenance level from a vehicle 186.

At maintenance level 182, maintenance data is derived from on-vehicle data, configuration data, replaced items data, cause of damage data and stores information. The maintenance data is transmitted as illustrated at 188 to the command level in which the command data includes maintenance data, on-vehicle data, metrics in terms of daily analysis and new fleet configurations.

Upon decision on such data, as illustrated at 190 the command level can communicate with the maintenance level to provide reconfiguring of the data which includes for instance a revised maintenance schedule or revised locations, with the configuration data from the maintenance level passed to the vehicle level as illustrated at 192 that reads current data and writes updates to configure vehicle level data such as PM/NM, interactive electronic technical manuals (IETMs) and fault code history.

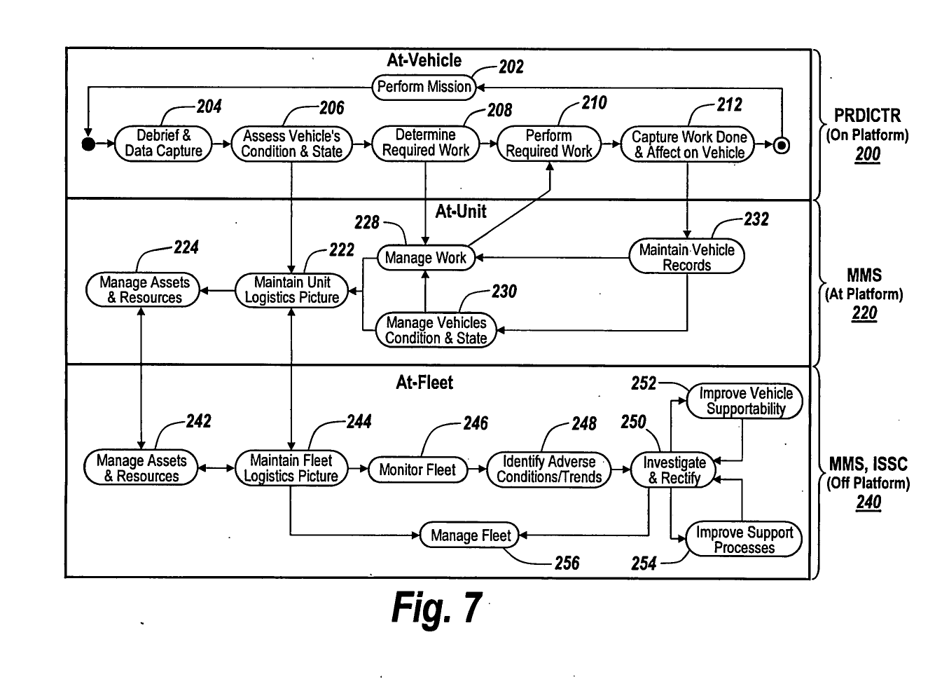

Referring now to FIG. 7 in a flow chart that relates to the operational activity model for the subject system, on-platform prognostication or predication algorithms 200 at a vehicle include an instruction 202 to perform the mission. This results in actions that result in data that in turn result in a debriefing and data capture operation 204, followed by an assessment of the vehicle's condition state at 206, which is in turn followed by a determination of the required work 208 to bring the vehicle back into the required condition. This is followed by the performance of the required work at the vehicle as illustrated at 210 and a capture process 212 which captures the work done and records the effect on the vehicle.

In terms of the maintenance management system operation at the platform as illustrated at 220, the assessment of the vehicle's condition and state at 206 is passed through to the maintenance unit's logistics picture 222 which is interconnected with a unit 224 that manages assets and resources.

Once the required work is determined at 208, this information is passed to a work manager 228 that manages the work involved and outputs information back to the required work performance step 210. Also involved in the manage work step is a manage vehicles condition and state step 230 which assists in organizing the work management by inputting the vehicle's condition and state to update a manage work step 228. Also performed at the vehicle is a step 232 involving the maintenance of vehicle which takes the output of the captured work done and the effect on the vehicle, to be able to more effectively manage the work that is required.

On the fleet level, the maintenance manage system of the in service support center is illustrated at 240 and includes a number of fleet management functions. As illustrated at 242 one of the functions is to mange assets and resources, whereas communication is required with the maintaining fleet logistics picture step 244. The fleet logistics picture is supplied to a fleet monitoring step 246 which is coupled to a step 248 that identifies adverse conditions and trends and instigates a procedure at 250 to rectify whatever faults or error conditions have been detected. The result of the investigation and rectification process is ported to a step 252 to improve vehicle supportability and at 254 to improve support processes. The result of this analysis is ported to a step 256 which gives an overall view of fleet management.

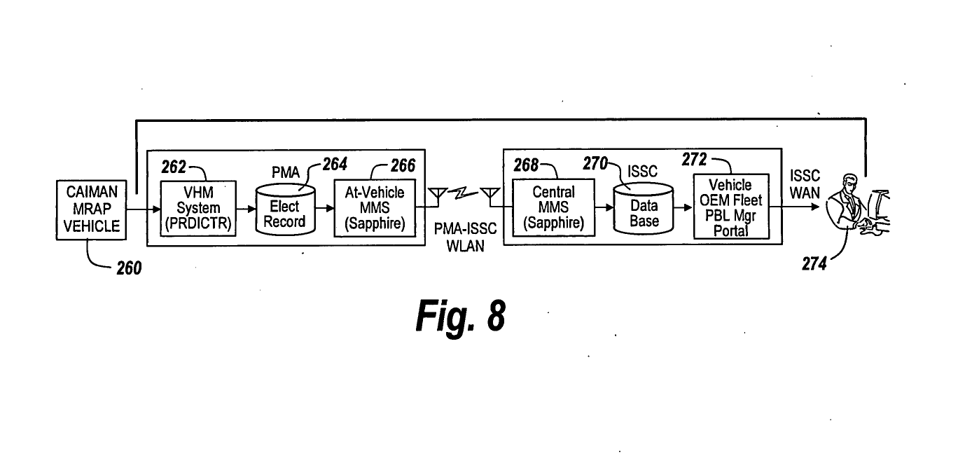

From a connectivity point of view and referring to FIG. 8, it can be seen that a vehicle 260 communicates its status to a vehicle health monitoring system module 262 which houses the above mentioned PRDICTR algorithms.

The output of the PRDICTR algorithm is stored as an elect record in portable maintenance aid 264 which outputs to an all vehicle maintenance management system unit 266 that wirelessly on an MMS protocol goes across a portable maintenance aid wide local area network to a central maintenance management system 268 that is turn coupled to a support center database 270, in turn coupled to vehicle operations and management fleet product baseline (PBL) manager portal 272. This provides a stakeholder 274, with the information directly from vehicle after having been processed by the subject support center.

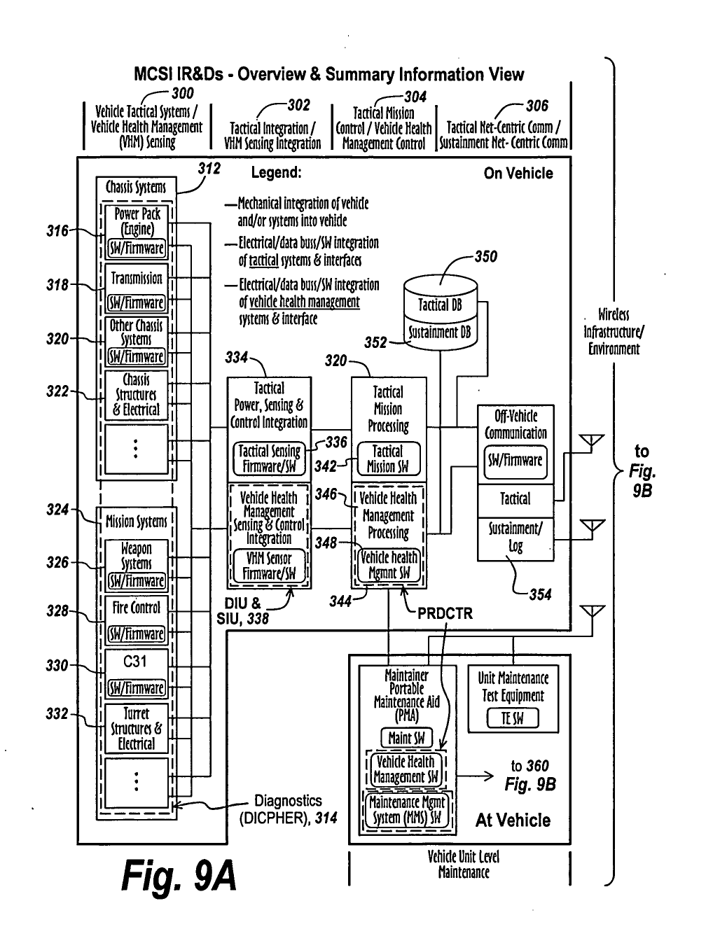

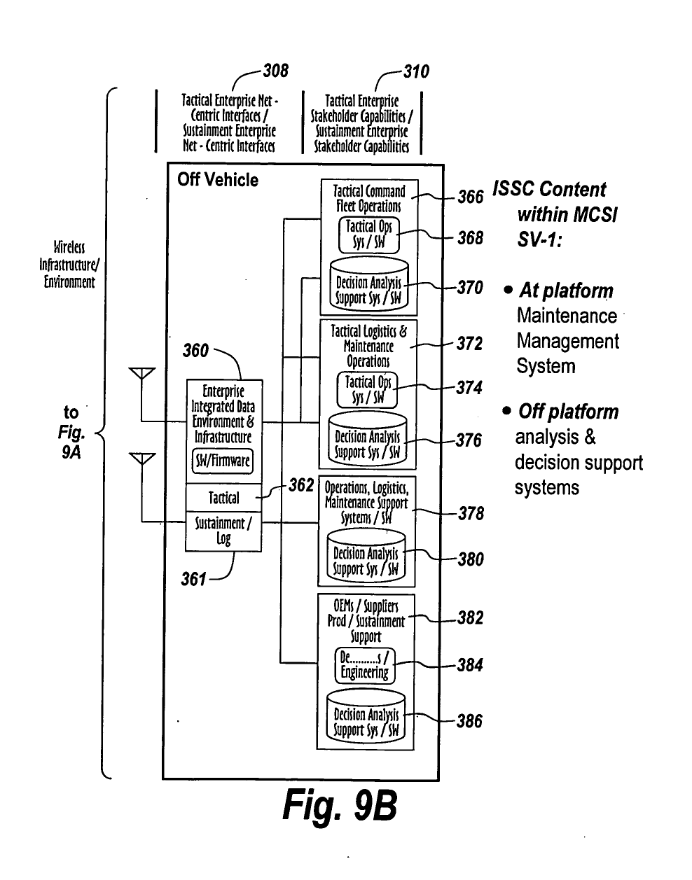

Finally referring to FIGS. 9A and 9B in more detail, a vehicle tactical system/vehicle health management vehicle health monitoring sensing system is illustrated at 300 followed by tactical integration/vehicle health management sensing integration at 302, in turn followed by tactical mission control/vehicle health management control 304.

The remainder of the on-vehicle functionality is a tactical net-centric communication/sustainment communications function 306.

With wireless communications between the on-vehicle and the off-vehicle equipment, as illustrated at 308 there is a tactical enterprise net-centric interfaces/sustainment enterprise off-board interface function. This is combined with a tactical enterprises stakeholder capability/sustainment enterprise stakeholder capabilities function 310.

Thus at the platform one has a maintenance management system, whereas off the platform one has an analysis and decision support system or systems.

In one embodiment, for a particular vehicle or chassis 312, there is a diagnostics set of functions as illustrated at 314 that include analysis of a power pack or engine 316, the transmission of the vehicle 318, other chassis systems 320, and chassis structures and electrical systems 322, all of which provide the inputs to the decipher or diagnostics function.

From the mission point of view as illustrated at 324, weapon systems 326, fire control systems 328, command, control, communications and intelligence (C3I) systems 330 and turret structures and electrical systems 332 are all inputs to the fleet management system.

Tactical integration and vehicle health monitoring sensing integration 302 is accomplished utilizing a tactical power, sensing and control integration function 334 coupled with a tactical sensing firmware and software function 336. This produces vehicle health management sensing and control integration 338 available at digital interface unit (DIU) and sensor interface unit (SIU) that includes vehicle health monitoring sensor firmware and software.

Tactical mission processing is accomplished at 340 which includes tactical mission software 342 and the PRDICTR portion 344 of the system which includes vehicle health management processing 346 and vehicle management software 348.

All of the data generated by the sensing system is stored in a tactical database 350 or sustainment database 352 where it is off-loaded by an off-vehicle communications module 354 and transmitted by a wireless link to off-vehicle devices, here shown by the enterprise integrated data environment infrastructure module 360 having its own software and hardware. Note, tactical data at 362 and sustainment logs 364 are available to the tactical enterprise shareholders at 310 through tactical command fleet operations 366 supplied with tactical operations systems and software 368 and decision and analysis support systems 370. Tactical logistics and maintenance operations are under the purview of module 372 that includes tactical operations systems and software 374 and decision analysis support systems and software 376. Operations logistics maintenance support systems and software is shown at 378 driven by decision analysis support system 380.

Original equipment manufacturers and suppliers have a product and sustainment function 382 supported by engineering and planning, performance, process and Innovative Solutions (P3I) software and hardware 384, all of which are driven by decision analysis support systems and software 386.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

1. Apparatus for the support of a vehicle fleet, comprising:
an in service support center comprising an information hub including a data storage module and a processing module in the form of a properly programmed computer to provide a specialized machine that operates by machine transformation to take data from said data storage module that collects information from a number of sources relating to vehicle condition and processes said information in an analysis module and an assessment system to provide stakeholders including at least one of manufacturing centers, maintenance centers and management centers by real time directly fed communication with information to assess vehicle fleet health and to provide maintenance and support information from said in service support center such that said in service support center enables the development of high level information, intelligence and situational awareness assessment over time, as well as fleet management awareness so as to reduce life cycle costs associated with a fleet, said in service support center providing an information hub to obtain, process and store vehicle maintenance and support information, said in service support center information hub including data acquisition services, data access services, a platform information database, an advisory generation unit, data analysis services and assessment visualization services.

2. The apparatus of claim 1, wherein said in service support center includes a reliability-centered maintenance tool.

3. The apparatus of claim 1, wherein said in service support center includes a condition-based maintenance tool.

4. The apparatus of claim 1, wherein said in service support center includes a fleet management tool.

5. The apparatus of claim 1, wherein said in service support center includes a vehicle or component asset tracking tool.

6. The apparatus of claim 1, wherein said in service support center includes a stores or consumable inventory.

7. The apparatus of claim 1, and further including an automatic information collecting module for collecting data from at least one of ground vehicles, personnel and strategic information points.

8. The apparatus of claim 1, wherein said in service support center includes a module for providing visibility of the location, configuration, condition and state of every vehicle in said fleet.

9. The apparatus of claim 1, wherein said in service support center is an off-platform support center for information collection, repository, analysis and assessment that uses all available automatic and manual means of data collection.

10. The apparatus of claim 1, wherein said in service support center establishes fielded ground truth utilizing on-board modules.

11. The apparatus of claim 10, wherein said on-board modules include modules to perform prognostics, diagnostics and sensors.

12. The apparatus of claim 1, wherein said in service support center includes a module for logging usage and for providing logistics information.

13. The apparatus of claim 1, wherein said in service support center is off-platform and further including an on-platform data collection module wirelessly coupled to said in service support center.

14. The apparatus of claim 1, wherein said in service support center processes information that includes enterprise maintenance information, logistics, reliability-centered maintenance, condition-based maintenance, and decision support and analysis.

15. The apparatus of claim 14, wherein the result of said analysis is ported to fleet health management experts.

16. The apparatus of claim 1, wherein information at said in service support center is made available to fleet maintainers.

17. The apparatus of claim 16, wherein said maintainers provide queries to said in service support center.

18. The apparatus of claim 17, wherein said queries includes a task to be logistically supported.

19. The apparatus of claim 17, wherein said queries include the location of parts.

20. The apparatus of claim 17, wherein said queries include what assets can be put into said task and when.

21. The apparatus of claim 17, wherein said queries include operational availability.

22. The apparatus of claim 1, and further including a portable maintenance aid coupled to said in service support center.

23. The apparatus of claim 22, wherein said portable maintenance aid provide at least one of data acquisition services, data assessment services and a platform information database.

24. The apparatus of claim 1, wherein said in service support center includes an advisory generation function, a data analysis function, an assessment function and a visualization function.

25. The apparatus of claim 1, wherein stakeholders utilizing said in service support center include at least one of tactical logistics fleet managers, life cycle managers, crews, maintenance and logistics support personnel in need or support, equipment manufacturers, organic logistics personnel and analysts.

26. The apparatus of claim 25, wherein said in service support center includes bi-directional communications modules between external databases and said support center database.

27. The apparatus of claim 1, wherein large amounts of data are supplied to said in service support center.

28. The apparatus of claim 1, wherein said in service support center includes modules for performing diagnostics or prognostics.

29. The apparatus of claim 1, wherein said in service support center is provided with the results of on-hoard diagnostics/prognostics.

30. The apparatus of claim 1, wherein said in service support center assesses the condition and state of a vehicle and provides said assessment to stakeholders, whereby said stakeholders are capable of managing assets and resources.

31. (canceled)
